(19) United States
(12) Patent Application Publication
(10) Pub. No.: US 2009/0173786 A1
(43) Pub. Date: Jul. 9, 2009

(54) COPPA-COMPLIANT WEB SERVICES

(75) Inventor: Craig Mitchell HATKOFF, New York, NY (US)

Correspondence Address: KENYON & KENYON LLP, ONE BROADWAY, NEW YORK, NY, 10004, US

(73) Assignee: TURTLE POND PUBLICATIONS, New York, NY (US)

(21) Appl. No.: 12/349,983

(22) Filed: Jan. 7, 2009

Related U.S. Application Data
(60) Provisional application No. 61/019,449, filed on Jan. 7, 2008.

(51) Int. Cl. G06K 5/00

(52) U.S. Cl. 235/380

(57) ABSTRACT

A system and method for providing to a minor access to a network information dissemination activity. Responsive to an interaction by the minor with a webpage of a website, an information dissemination machine determines whether the interaction is a triggering action. Where a triggering action is determined to have occurred, a credit card transaction form for completing a credit card transaction is provided at a client input/output device. Responsive to completion of the credit card transaction, access to performance of an activity via a further interaction with the website is provided to the minor.

### CROSS-REFERENCE TO RELATED APPLICATIONS

This application claims priority to U.S. Provisional Patent Application No. 61/019,449, filed Jan. 7, 2008, which is herein incorporated by reference in its entirety.

### FIELD OF THE INVENTION

The present invention relates to a system and method for controlled dissemination of a minor's personal information over a network. More specifically, the present invention relates to a system and method that provides for web traffic compliance with the Children's Online Privacy & Protection Act (COPPA).

### BACKGROUND INFORMATION

The COPPA guidelines mandate parental consent or notification prior to a minor disseminating personal information through the Internet. Existing COPPA compliant systems require parental consent through a signature, such as by a parent filling out, signing, and then sending to a content provider a form. This technique, while very effective for insuring parental consent, is a cumbersome and time consuming process. The process requires the parent to request the consent form, print out the form, fill out the form, and send in the form either via the mail, as electronic mail as a scanned in attachment, or by facsimile. All the while, the child wishing to use the web site is restricted from using any features that are governed by COPPA guidelines.

### SUMMARY OF THE INVENTION

According to an example embodiment of the present invention, a system for providing to a minor access to a network information dissemination activity may include a website hosting server including a processor. The processor may be configured to transmit a webpage of a website to a client terminal operated by a minor; receive notification of an interaction by the minor with the webpage; responsive to receipt of the notification, determine whether the interaction is a triggering action; and, where a triggering action is determined to have occurred: have a credit card transaction form for completing a credit card transaction transmitted to the client terminal; and responsive to completion of the credit card transaction, provide access to performance of an activity via a further interaction with the website. In an alternative example embodiment, the client terminal, e.g., a web browser running on the client terminal, may perform the step of determining whether the interaction is a triggering action. In a further alternative example embodiment, the credit card form may be locally stored and retrieved upon determination of the triggering action.

In an example embodiment of the present invention, the website hosting server transmits a request to a credit card company system for providing the credit card transaction form.

In an example embodiment of the present invention, the credit card transaction is conducted between the client terminal and the credit card company system, and the website hosting server receives a notification of the completion of the credit card transaction.

In an example embodiment of the present invention, when the triggering action is determined to have occurred, the processor determines whether the activity is covered by a previously obtained parental consent. Further, the processor has the transmission of the credit card transaction form performed conditional upon that the processor determines that the activity is not covered by any previously obtained parental consent, the access being otherwise provided without the completion of the credit card transaction.

In an example embodiment of the present invention, the processor stores a record of the completion of the credit card transaction. In response to occurrence of a further triggering action, the processor determines that a further activity associated with the further triggering action is covered by parental consent based on the record. The processor provides access to performance of the further activity in response to the determination that the further activity is covered by the parental consent.

In an example embodiment of the present invention, all activities of the website are determined to be covered by parental consent based on the record.

In an example embodiment of the present invention, activities are classified by type, and all activities of the website that are of a same type as that of the activity are determined to be covered by parental consent based on the record.

In an example embodiment of the present invention, a repeated performance of the activity is determined to be covered by parental consent based on the record.

In an example embodiment of the present invention, the website hosting server transmits the credit card transaction form to the client terminal and conducts the credit card transaction with the client terminal.

In an example embodiment of the present invention, the credit card transaction includes charging a credit card a fee.

In an example embodiment of the present invention, no credit card charge is made in the credit card transaction.

In an example embodiment of the present invention, responsive to the credit card transaction, the processor transmits an e-mail to an e-mail address, the e-mail including notification of the transaction and the activity.

In an example embodiment of the present invention, responsive to the credit card transaction, the processor transmits an e-mail to an e-mail address, the e-mail including a code. The processor provides a form including a field for entry of the code. The access is provided conditional upon the entry of the code.

In an example embodiment of the present invention, responsive to the credit card transaction, the processor transmits an e-mail to an e-mail address associated by a credit card company system with a credit card used for the transaction, the e-mail including notification of at least one of the transaction and the activity.

According to example embodiments of the present invention, a method of a network dissemination machine for providing to a minor access to a network information dissemination activity includes, responsive to an interaction by the minor with a webpage of a website, the machine determining whether the interaction is a triggering action. The method further includes, where a triggering action is determined to have occurred: providing at a client input/output device a credit card transaction form for completing a credit card transaction; and, responsive to completion of the credit card transaction, the machine providing access to performance of an activity via a further interaction with the website.

According to an example embodiment of the present invention, a hardware-implemented computer-readable medium having stored thereon instructions executable by a processor is provided. Execution of the instructions cause the processor to perform a method for providing to a minor access to a network information dissemination activity. The method includes, responsive to an interaction by the minor with a webpage of a website, the processor determining whether the interaction is a triggering action. The method further includes, where a triggering action is determined to have occurred: providing at a client input/output device a credit card transaction form for completing a credit card transaction; and, responsive to completion of the credit card transaction, the processor providing access to performance of an activity via a further interaction with the website.

### BRIEF DESCRIPTION OF THE DRAWINGS

FIG. 1 is a block diagram that illustrates components of a system according to an example embodiment of the present invention.

FIG. 2 is a flowchart that illustrates steps of a process according to an example embodiment of the present invention.

### DETAILED DESCRIPTION

The present invention provides a system and method that provides for COPPA-compliant web services without the drawbacks of the conventional systems. Embodiments of the present invention make use of a credit card transaction system. The web service allows a parent to make a nominal charge on the credit card. The transaction and approval of the nominal charge then serves as parental consent. The credit card transaction may operate as a typical transaction where the parent enters all the normal credit card information (e.g., number, expiration date, verification code, etc.). Then, with the processing of the credit card transaction and the subsequent parental consent, the web site thereby authorizes the child to use the web site for various COPPA-governed activities.

The COPPA-compliance system may operate in conjunction with a children-themed website, such as the World Wide Web“.com” address of “owenandmzee.” For example, the user is presented with various activities, including generating a song or writing a story, where the term user refers to a child, which may or may not be accompanied by a parent or guardian. The user reaches a junction in the activity where parental permission is necessary in order to continue. By way of example, suppose the user is following predefined templates for writing a story. The user may be presented with blank entry fields and asked to enter information, such as the user's name and other information. Under the COPPA guidelines, the web site requires parental consent before the information is disseminated. For example, dissemination may include generating a web log (also known as a blog), posting the story on a publicly accessible web location, or electronically mailing the generated story.

It is understood that different activities and different types of information trigger COPPA provisions at different times. The present invention provides an efficient system for achieving this parental notification and assumes that this system is activated based on activities as recognized by the web site or an online service provider.

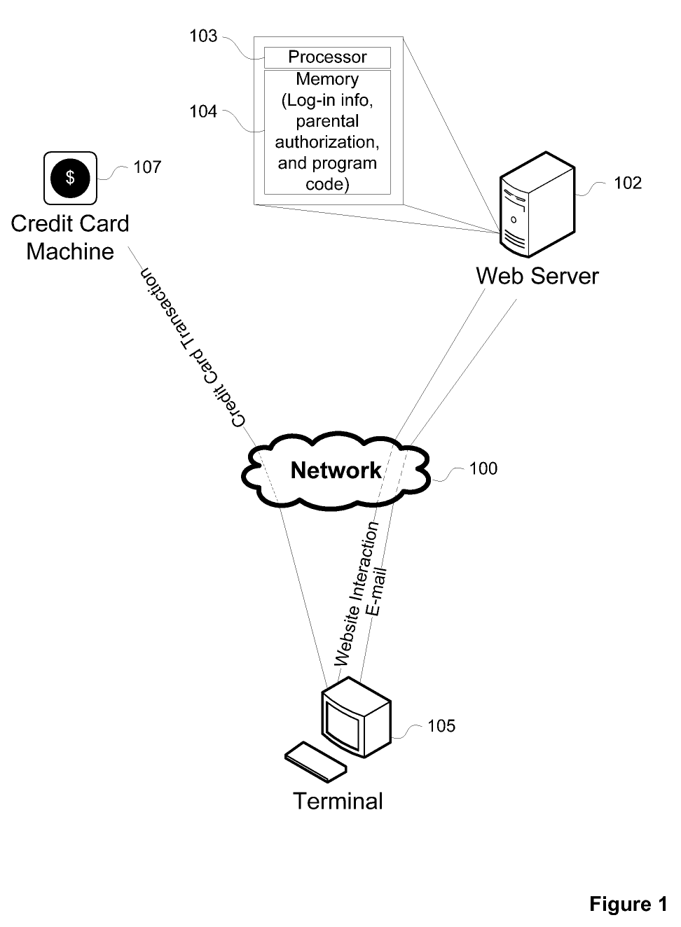

FIG. 1 is a diagram that illustrates components of a system according to an example embodiment of the present invention. The system may include a web server 102 that hosts a website. The web server 102 may communicate with a terminal 105 via a network 100, e.g., the Internet, to receive webpage requests and browser information and provide web pages of the website in a website interaction. The system may further include a credit card machine 107 separate from or integral with the web server 102. According to the embodiment in which the credit card machine is separate from the web server 102, the web server 102 and the credit card machine 107 may communicate with each other regarding a credit card transaction conducted with the terminal 105 via the network 100 or some other network. According to this embodiment, communication between the credit card machine 107 and the terminal 105 may be omitted. Alternatively, the credit card machine 107 and the terminal 105 communicate based on instructions in website information received by the terminal 105 from the web server 102. The terminal 105 may report transaction information related to a credit card transaction conducted with the credit card machine 107 to the web server 102.

The web server 102 may include a processor 103 and a memory 104. The processor may be any conventional processor. The memory 104 may include any conventional memory device or combination thereof, such as a hard drive, tape, CD, etc. The memory 104 may have stored thereon program code which may be executed by the processor 103 to perform the various methods discussed herein, including processing of web page requests, credit card transactions, and parental authorization steps. Some of these steps may alternatively be performed locally at the terminal 105. For example, the web server 102 may transmit instructions to the web browser at the terminal 105 for processing of an activity as described below and for conducting a credit card transaction with the credit card machine 107.

The memory 104 or a memory at the terminal 105 may store log-in information and/or information regarding past parental authorization, as described below.

The terminal 105 may be any conventional computing terminal including or in communication with any suitably appropriate processing machine and memory device. The processing performed by the various described components may be via hardware devices executing software instructions.

Once the COPPA-compliance activity is recognized, e.g., at the terminal 105 or the web server 102, the system determines if parental consent has been received by checking the memory 104. (It is understood that parts of the memory 104 may be at the terminal 105 rather than at the web server 102.) If not, the user is then prompted to find a parent. This prompt may include a pop-up screen that includes the instructions “Find your mommy or daddy, and tell them to bring their credit card!” or any other type of notification.

To continue using the web service for the activity that prompted the COPPA guidelines, the parent is then presented with a transaction screen. Prior to the transaction screen, the parent may establish an online account with the web service or if an account is already established, log in under an existing username and password. Additionally, this online account may be associated with a child's account. The log-in information may be stored at the web server 102 or the terminal 105. Storing the information at the web server 102 allows for more flexibility in that the information can be accessed regardless of the terminal being used for interaction with the website.

For usability, the parent may first be given information on the reason for the credit card transaction (e.g., COPPA-compliance) and how the credit card transaction serves as parental consent. The transaction may be a nominal amount, such as a $1 donation to the web service or in another technique, the donation may be to a project or cause associated with or related to the web service, for example, if the web service is about animals on a nature preserve, the donation may be made to a wildlife fund. It is also understood that the transaction may not even include a nominal amount, but may simply process a zero transaction, akin to when a user checks into a hotel and a credit check is done using a credit card without any monetary charge.

The credit card transaction screen may include a typical credit card information data entry screen and an email address to send a subsequent consent notification. The transaction screen may also include field(s) specifically associated with the parental consent. For example, the transaction screen may include text describing the activity that the user (child) was engaged in that triggered the parental consent requirement. One activity may be a child making a song on the web site, where the COPPA guidelines became in effect when the child attempted to send the song to friends. Therefore, the transaction screen may include the text instructing the parent that they are giving consent for their child to send a song they recorded to other users. In addition, the screen may include explicit text about the parental consent, such as “Your donation of $1.00 will confirm your permission. You will receive an email with a confirmation code. Please enter this code in the following screen.”

Thus, once the parent enters the credit card information and electronically gives consent, the system thereby processes the nominal transaction. This credit card transaction may be processed using known processing techniques that are commonly and widely used in various electronic commerce engines. In another embodiment, the transaction may be processed through a dedicated system or process aside from standard consumer credit transactions.

There may be existing relationships between the web service provider and the credit card company such that the credit card company waives processing fees and is considered a sponsor, donor or supporter of the web site or a related activity. Additionally, the web site may restrict the credit card brand it accepts or processes, such as only accepting American Express cards.

In one embodiment, on the web site, the consent is considered to have been given once the parent fills out the credit card form, without requiring additional entry for the user to proceed, although, redundancy in the system may also include an email verification process. For example, this step may prevent a child from improperly using the parent's credit card to gain improper consent because the child would have to not only access the parent's credit card, but also the parent's email account.

As another safegaurd, the email notification may be tied into the credit card system. For example, many credit card users have email addresses on record with their credit card companies for account notifications, paperless statements, transaction verifications, etc. The notification email may be processed and sent to the email address on record at the credit card company. The email may be sent from the system hosting the credit card machine 107 and/or from the web server 102. The email may be accessed by any email accessing device, including, e.g., a PDA, phone, and/or the terminal 105 or any other computer terminal.

Once the credit card transaction is processed, the transaction serves as an indicator of parental consent. A consent notification is sent to the parent's email address. It is understood that other consent notification techniques may be utilized, such as physically sending the parent a letter in the mail, faxing the parent a letter, sending an SMS message, or any other type of notification.

In an example embodiment, on the website, before the user (child) is allowed to continue the activity, the parent must enter information from the consent notification. In one example, this may be a code, password or randomly generated series of numbers and/or letters. In a consent notification screen, the parent may be presented with a pop-up window that asks “Please enter your parental permission confirmation number.” The parent may then enter this number in a box or field and select a done or send button.

This consent thereby satisfies the COPPA requirements and the user (child) is free to return to the triggering activity. For example, a pop-up screen may announce to the parent and child “Congratulations, Now we can share your song with a friend!”

The parental consent may be in one of two possible forms. A first form is a generalized consent for unfettered child access to all of the web activities on the web site. This consent form may be accomplished by a cookie or other piece of software resident on the user's computer or may be controlled on the back-end with the web service system. In one embodiment, the user may create an account and have a login for the account. Universal consent may be noted on the account so that when the child logs in, the child can then freely access different COPPA activating activities.

A second parental consent form is specific to the individual task or task type. Using the above example of sharing a song with a friend, the user may be given full access to share that particular song with friends (specific to the individual task) or may be given full access to share any number of different songs with friends (specific to the individual task type). Further, the parent may be provided with the option of limiting consent to a specified time period, e.g., the next hour. In this type of parent consent, the user would still be restricted from COPPA activating activities outside the scope of the consent. This way, a parent can more accurately monitor their child's Internet activities.

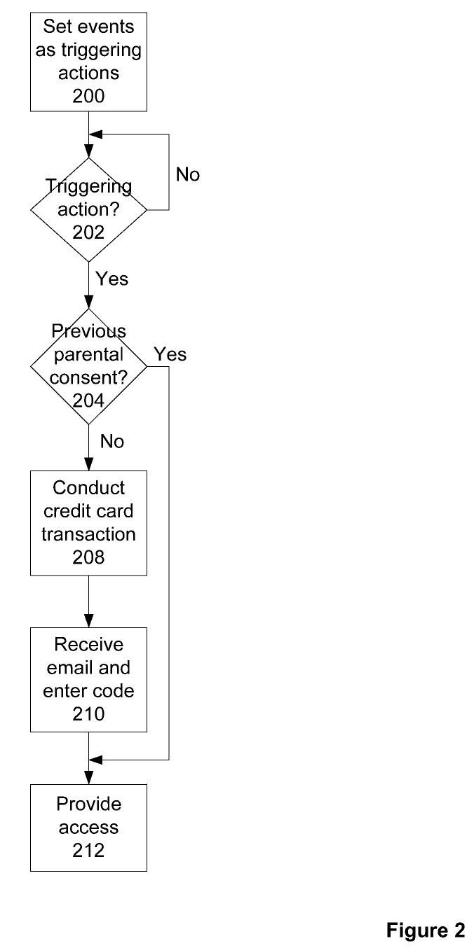

FIG. 2 shows a flowchart of steps that may be performed according to example embodiments of the present invention. At step 200, events may be set as triggering actions. At step 202, the system may compare an event to a stored triggering action to determine whether a triggering action has occurred.

If a triggering action is determined to have occurred, the system may, at 204, check stored parental consent information to determine whether the action falls in the scope of a previously received and still valid parental consent. If previous consent is determined to have been received, the system may proceed to step 212. Otherwise, the system may, at 208, conduct a credit card transaction with a parent.

At step 210, an email account of the parent may receive an email noting the credit card transaction, the parental consent, and/or a code. In the embodiment in which the code is sent, the code may be entered.

At step 212, the system may provide access to performance of the activity. According to the embodiment in which a code need not be entered for access, step 210 may omit the entering of a code and steps 210 and 212 may be occur concurrently.

Thereby, through the use of a credit card transaction system, COPPA-compliant parental permission may be quickly and efficiently acquired allowing the children users to utilize the web site.

Embodiments of the present invention are directed to one or more processors, each implemented via any conventional computing device or combination of computing devices, and programmed to perform the above described methods.

Embodiments of the present invention are directed to a computer readable medium having stored thereon instructions executable by a processor, the execution of the instructions causing a processor to perform the above described methods. The medium may include any conventional hardware memory device, such as RAM, ROM, CD, or tape.

Embodiments of the present invention are directed to a method performed by a machine, the method including transmission of instructions executable by a processor to perform the above described methods.

Those skilled in the art can appreciate from the foregoing description that the present invention may be implemented in a variety of forms, that the various embodiments may be implemented alone or in combination, and that the above described example embodiments are not used for limiting the present invention. Moreover, it will be appreciated that the described steps may be performed by the website hosting server, locally at the user's terminal, or via a combination of the two. For example the website server or the user terminal, e.g., the web browser at the user's terminal, may determine whether a triggering action occurred, whether consent had been previously given, and/or the scope of any previously provided consent. Further, as described above, steps may be performed by a server of a credit card company. Therefore, while the embodiments of the present invention have been described in connection with particular examples thereof, the true scope of the embodiments of the present invention should not be so limited since other modifications will become apparent to the skilled practitioner upon a study of the drawings, specification, and following claims.

What is claimed is:

1. A system for providing to a minor access to a network information dissemination activity, comprising:
a website hosting server including a processor configured to:
transmit a webpage of a website to a client terminal operated by a minor;
receive notification of an interaction by the minor with the webpage;
responsive to receipt of the notification, determine whether the interaction is a triggering action; and
where a triggering action is determined to have occurred:
have a credit card transaction form for completing a credit card transaction transmitted to the client terminal; and
responsive to completion of the credit card transaction, provide access to performance of an activity via a further interaction with the website.

2. The system of claim 1, wherein the website hosting server transmits a request to a credit card company system for providing the credit card transaction form.

3. The system of claim 2, wherein the credit card transaction is conducted between the client terminal and the credit card company system and the website hosting server receives a notification of the completion of the credit card transaction.

4. The system of claim 1, wherein:
when the triggering action is determined to have occurred, the processor determines whether the activity is covered by a previously obtained parental consent;
the processor has the transmission of the credit card transaction form performed conditional upon that the processor determines that the activity is not covered by any previously obtained parental consent, the access being otherwise provided without the completion of the credit card transaction.

5. The system of claim 1, wherein:
the processor stores a record of the completion of the credit card transaction;
in response to occurrence of a further triggering action, the processor determines that a further activity associated with the further triggering action is covered by parental consent based on the record; and
the processor provides access to performance of the further activity in response to the determination that the further activity is covered by the parental consent.

6. The system of claim 5, wherein all activities of the website are determined to be covered by parental consent based on the record.

7. The system of claim 5, wherein activities are classified by type, and all activities of the website that are of a same type as that of the activity are determined to be covered by parental consent based on the record.

8. The system of claim 5, wherein a repeated performance of the activity is determined to be covered by parental consent based on the record.

9. The system of claim 1, wherein the website hosting server transmits the credit card transaction form to the client terminal and conducts the credit card transaction with the client terminal.

10. The system of claim 1, wherein the credit card transaction includes charging a credit card a fee.

11. The system of claim 1, wherein no credit card charge is made in the credit card transaction.

12. The system of claim 1, wherein, responsive to the credit card transaction, the processor transmits an e-mail to an e-mail address, the e-mail including notification of the transaction and the activity.

13. The system of claim 1, wherein:
responsive to the credit card transaction, the processor transmits an e-mail to an e-mail address, the e-mail including a code;
the processor provides a form including a field for entry of the code; and
the access is provided conditional upon the entry of the code.

14. The system of claim 1, wherein, responsive to the credit card transaction, the processor transmits an e-mail to an e-mail address associated by a credit card company system with a credit card used for the transaction, the e-mail including notification of at least one of the transaction and the activity.

15. A method of a network dissemination machine for providing to a minor access to a network information dissemination activity, the method comprising:
responsive to an interaction by the minor with a webpage of a website, the machine determining whether the interaction is a triggering action; and
where a triggering action is determined to have occurred:
providing at a client input/output device a credit card transaction form for completing a credit card transaction; and
responsive to completion of the credit card transaction, the machine providing access to performance of an activity via a further interaction with the website.

16. A hardware-implemented computer-readable medium having stored thereon instructions executable by a processor, execution of the instructions causing the processor to perform a method for providing to a minor access to a network information dissemination activity, the method comprising:
responsive to an interaction by the minor with a webpage of a website, the processor determining whether the interaction is a triggering action; and
where a triggering action is determined to have occurred:
providing at a client input/output device a credit card transaction form for completing a credit card transaction; and
responsive to completion of the credit card transaction, the processor providing access to performance of an activity via a further interaction with the website.
